(19) United States
(12) Patent Application Publication
(10) Pub. No.: US 2002/0000364 A1
(43) Pub. Date: Jan. 3, 2002

(54) Push-pull type micromachined microwave switch

(76) Inventors: Soung-Cheol Hong, Taejon (KR); Eui-Sik Yoon, Taejon (KR); Doo-Young Ha, Taejon (KR)

Correspondence Address: BACON & THOMAS, PLLC, 625 Slaters Lane - 4th Floor, Alexandria, VA, 22314-1176, US

(21) Appl. No.: 09/765,651

(22) Filed: Jan. 22, 2001

(30) Foreign Application Priority Data
May 24, 2000 (KR) 10-2000-28034

(51) Int. Cl. H01H 57/00

(52) U.S. Cl. 200/181

(57) ABSTRACT

Disclosed is a push-pull type micromachined microwave switch using torsion springs and a lever fabricated using a surface micromachining technique so that it operates at a low operating voltage. The microwave switch includes an insulating base plate, fixed electrodes arranged on the insulating base plate, a plurality of fixed shafts attached to the base plate and adapted to firmly support a plurality of torsion springs, respectively, the torsion springs each connected at one end thereof to an associated one of the fixed shafts, a rotating plate arranged over the fixed electrodes to face the fixed electrodes and connected to respective other ends of the torsion springs, a rotating electrode attached to an upper surface of the rotating plate, a lever connected at one end thereof to the rotating plate, a movable contact electrode attached to a lower surface of the lever at the other end of the lever so that it is firmly supported by the lever, and a transmission line arranged on the base plate so that it faces the movable contact electrode.

### BACKGROUND OF THE INVENTION

1. Field of the Invention

The present invention relates to a microwave switch with a push-pull configuration, and more particularly to a push-pull type micromachined microwave switch using torsion springs and a lever fabricated using a surface micromachining technique so that it operates at a low operating voltage.

2. Description of the Related Art

In accordance with an abrupt increase in the use of mobile communication systems recently made, development of miniature mobile communication systems having diverse functions have been highlighted.

Conventionally, semiconductor devices such as field effect transistors (FETs) and pin diodes have been used as microwave switches. However, such semiconductor devices have drawbacks of a high insertion loss and a degraded isolation.

In order to solve such drawbacks, a microwave switch has been proposed by Larson, et al. in the early years of the 1990's. This microwave switch is fabricated using a micromachining technique based on a large scale integration (LSI). The microwave switch exhibits a low insertion loss, a high isolation resulting in superior insulation characteristics, and an excellent linearity, as compared to conventional switches constituted by semiconductor switches.

However, most of known microwave switches involve a problem in that a high operating voltage is required because those microwave switches are fabricated using a micromachining technique.

Typically, the operating voltage used in such microwave switches is 20 V or more. There are also microwave switches requiring a voltage of at least 8 V. For this reason, it is difficult to apply such microwave switches to miniature mobile communication terminals. An example of microswitches requiring a high operating voltage, as mentioned above, will now be described.

A micromachined microwave switch using a flexible moving construction having a cantilever structure (Proceeding of The 8th Int'l Conf. on Solid-State Sensors and Actuators (1995), J. J. Yao and M. F. Chang, pp. 384-387) uses an operating voltage ranging from 28 V to 50 V. In the case of a micromachined microwave switch using a flexible moving construction having a bridge structure (IEEE, Microwave and Guided Wave Letters, C. Goldsmith et al., pp. 269-271), an operating voltage of 50 V is used.

In order to lower the operating voltage in such a microwave switch fabricated using a micromachining technique, the distance between a transmission line and a movable contact electrode should be reduced. However, the reduced distance results in an increase in off-capacitance, thereby causing a degradation in isolation. The operating voltage may be lowered using a method in which the geometrical size of the moving construction is optimized. In most cases, this method involves a problem in that a high residual stress is generated.

Another method has been proposed by Milanovic, et al. In accordance with this method, a push-pull construction is coupled to a microswitch to reduce the operating voltage of the microswitch. By virtue of the push-pull construction, this microswitch exhibits characteristics strong against physical impacts resulting from vibrations or a potential difference between ON/OFF states thereof.

However, this microswitch with the push-pull configuration cannot achieve a considerable improvement in isolation because the maximum level of its movable contact electrode obtained in a state, in which the movable contact electrode is raised after being separated from a signal line, is limited to two times the initial level of the movable contact electrode.

### SUMMARY OF THE INVENTION

Therefore, the present invention has been made in view of the above mentioned problems, and an object of the present invention is to provide a push-pull type micromachined microwave switch exhibiting a low insertion loss while exhibiting a high isolation.

Another object of the invention is to provide a push-pull type micromachined microwave switch using a low operating voltage.

In accordance with one aspect, the present invention provides a push-pull type micromachined microwave switch comprising: an insulating base plate; fixed electrodes arranged on the insulating base plate; a plurality of fixed shafts attached to the base plate and adapted to firmly support a plurality of torsion springs, respectively; the torsion springs each connected at one end thereof to an associated one of the fixed shafts; a rotating plate arranged over the fixed electrodes to face the fixed electrodes and connected to respective other ends of the torsion springs; a rotating electrode attached to an upper surface of the rotating plate; a lever connected at one end thereof to the rotating plate; a movable contact electrode attached to a lower surface of the lever at the other end of the lever so that it is firmly supported by the lever; and a transmission line arranged on the base plate so that it faces the movable contact electrode.

Preferably, the microwave switch comprises two torsion springs and two fixed shafts.

Preferably, the torsion springs, the rotating plate, and the lever are made of an insulator.

The microwave switch may comprise two fixed electrodes, that is, a push electrode and a pull electrode. Alternatively, the microwave switch may comprise three fixed electrodes, that is, a push electrode, a pull electrode, and a bending electrode.

The transmission line may be a microstrip line. Alternatively, the transmission line is a coplanar waveguide.

Preferably, the transmission line is divided into two line portions defining a gap therebetween, the gap facing the movable contact electrode.

Each of the torsion springs may have a straight bar shape. Alternatively, each of the torsion springs may have a shape provided with irregularities.

In accordance with another aspect, the present invention provides a push-pull type micromachined microwave switch comprising: an insulating base plate coupled to a microwave ground; fixed electrodes arranged on the insulating base plate; a plurality of fixed shafts attached to the base plate and adapted to firmly support a plurality of torsion springs, respectively; the torsion springs each connected at one end thereof to an associated one of the fixed shafts; a rotating plate arranged over the fixed electrodes to face the fixed electrodes and connected to respective other ends of the torsion springs; a rotating electrode attached to an upper surface of the rotating plate; a lever connected at one end thereof to the rotating plate; a movable contact electrode attached to a lower surface of the lever at the other end of the lever so that it is firmly supported by the lever; and a transmission line arranged on the base plate so that it faces the movable contact electrode.

Preferably, the microwave switch comprises two torsion springs and two fixed shafts.

Preferably, the torsion springs, the rotating plate, and the lever are made of a conductor.

Preferably, the microwave switch comprises two fixed electrodes, that is, a push electrode and a pull electrode.

The transmission line may be a microstrip line. Alternatively, the transmission line is a coplanar waveguide.

Preferably, the transmission line is provided with a dielectric at an upper surface thereof.

Each of the torsion springs may have a straight bar shape. Alternatively, each of the torsion springs may have a shape provided with irregularities.

### BRIEF DESCRIPTION OF THE DRAWINGS

The above objects, and other features and advantages of the present invention will become more apparent after a reading of the following detailed description when taken in conjunction with the drawings, in which:

FIG. 1 is a perspective view illustrating a push-pull type micromachined microwave switch in accordance with an embodiment of the present invention;

FIG. 2a is a side view illustrating a zero bias state of the push-pull type micromachined microswitch according to the illustrated embodiment of the present invention;

FIG. 2b is a side view illustrating an ON state (that is, ON state of Vₚᵤₗₗ)of the push-pull type micromachined microswitch according to the illustrated embodiment of the present invention;

FIG. 2c is a side view illustrating an OFF state (that is, ON state of Vₚᵤₛₕ) of the push-pull type micromachined microswitch according to the illustrated embodiment of the present invention;

FIG. 3 is a graph depicting a variation in the angle of the rotation generated in the push-pull type micromachined microswitch according to the illustrated embodiment of the present invention, depending on the voltage applied.

FIG. 4a is a graph depicting a variation in the threshold voltage, Vₜₕ, of the push-pull type micromachined microswitch according to the illustrated embodiment of the present invention, depending on a variation in the width of a torsion spring, Wₛ, and a variation in the length of the torsion spring, lₛ;

FIG. 4b is a graph depicting a variation in the threshold voltage, Vₜₕ, of the push-pull type micromachined microswitch according to the illustrated embodiment of the present invention, depending on a variation in the initial height of a movable contact electrode, h₀, and a variation in the thickness of the torsion spring, tₛ;

FIG. 4c is a graph depicting a variation in the threshold voltage, Vₜₕ, of the push-pull type micromachined microswitch according to the illustrated embodiment of the present invention, depending on a variation in the length of a lower electrode, l_{be}, a variation in the length of an upper electrode, lₜₑ, and the width of a rotating electrode, Wₜₑ;

FIG. 5a is a circuit diagram illustrating an RF model established in the ON state of the push-pull type micromachined microswitch according to the illustrated embodiment of the present invention;

FIG. 5b is a circuit diagram illustrating an RF model established in the OFF state of the push-pull type micromachined microswitch according to the illustrated embodiment of the present invention;

FIG. 6a is a graph depicting RF characteristics exhibited in the ON state of the push-pull type micromachined microswitch according to the illustrated embodiment of the present invention;

FIG. 6b is a graph depicting RF characteristics exhibited in the OFF state of the push-pull type micromachined microswitch according to the illustrated embodiment of the present invention;

FIGS. 7a to 7d are cross-sectional views respectively illustrating sequential processing steps of a procedure for fabricating the push-pull type micromachined microwave switch according to the present invention;

FIG. 8 is a graph depicting a variation in capacitance in the push-pull type micromachined microswitch according to the illustrated embodiment of the present invention, depending on the applied voltage;

FIG. 9 is a graph depicting respective variations in voltages Vₚᵤₗₗ and Vₚᵤₛₕ in the push-pull type micromachined microswitch according to the illustrated embodiment of the present invention, depending on a variation in the length of the upper rotating electrode, lₜₑ;

FIG. 10 is a waveform diagram illustrating a dynamic response of the push-pull type micromachined microswitch according to the illustrated embodiment of the present invention;

FIG. 11 is a graph depicting characteristics exhibited in the ON state of the push-pull type micromachined microswitch according to the illustrated embodiment of the present invention; and

FIG. 12 is a graph depicting characteristics exhibited in the OFF state of the push-pull type micromachined microswitch according to the illustrated embodiment of the present invention.

### DESCRIPTION OF THE PREFERRED EMBODIMENTS

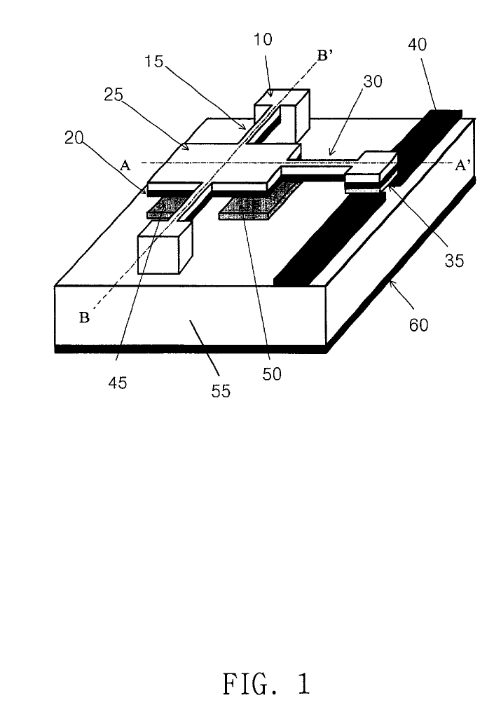

FIG. 1 is a perspective view illustrating a push-pull type micromachined microwave switch in accordance with an embodiment of the present invention. This microwave switch includes a plurality of fixed shafts 10 attached to a base plate 55 provided at a lower surface thereof with a ground layer 60. The fixed shafts 10 serve to firmly support a plurality of torsion springs 15, respectively. Preferably, the microwave switch includes two torsion springs and two fixed shafts, as shown in FIG. 1. Each torsion spring 15 is integrally connected at one end thereof to an associated one of the fixed shafts 10. Each of the torsion springs may have a straight bar shape, as shown in FIG. 1. Alternatively, each of the torsion springs may have a shape provided with irregularities. The microwave switch also includes a rotating plate 20 to which the other end of each torsion spring 15 is connected. The rotating plate 20 is made of an insulator and arranged to face fixed electrodes, that is, a push electrode 45 and a pull electrode 50, attached to the upper surface of the base plate 55. A rotating electrode 25 is attached to the upper surface of the rotating plate 20. A lever 30 is connected at one end thereof to the rotating plate 20 and adapted to firmly support a movable contact electrode 35. This movable contact electrode 35 is attached to the lower surface of the lever 30 at the other end of the lever 30. Although the microswitch has been illustrated to include two fixed electrodes, that is, the push electrode 45 and pull electrode 50, it may further include, as another fixed electrode, a bending electrode (not shown) attached to the base plate 55 and arranged to face a portion of the lever 30. The microwave switch further includes a transmission line 40 attached to the upper surface of the base plate 55 in such a fashion that it faces the movable contact electrode 35. The transmission line 40 has two separate portions defining a gap therebetween. The movable contact electrode 35 is arranged over the gap of the transmission line 40. In the case illustrated in FIG. 1, the transmission line 40 has a microstrip structure. Alternatively, the transmission line 40 has a coplanar waveguide structure. The transmission line may be provided with a dielectric at an upper surface thereof facing the movable contact electrode 35. Initially, the movable contact electrode 35 is not in contact with the transmission line 40, so that the microwave switch is in its OFF state. When the movable contact electrode 35 is downwardly pulled by virtue of a static electromotive force, it comes into contact with the transmission line 40, thereby causing the microswitch to be switched to its ON state. In the ON state of the microswitch, the transmission line 40 can transmit a signal therethrough. In this case, the isolation (insulation) of the microswitch is determined by a capacitance C_{off} formed between the movable contact electrode 35 and the transmission line 40 in the OFF state of the microswitch. Generally, capacitance is inversely proportional to the distance between two electrodes. In the illustrated case, accordingly, the insulation increases when the movable contact electrode 35 is raised to a higher level by virtue of a static electromotive force. To this end, the microswitch has a push-pull configuration. In order to achieve a desired operation using a low switch operating voltage, the microswitch uses the torsion spring 15 and the lever 30. The movable contact electrode 35 is physically supported by the lever 30 while being electrically insulated from the lever by an insulator extending from the rotating plate 20.

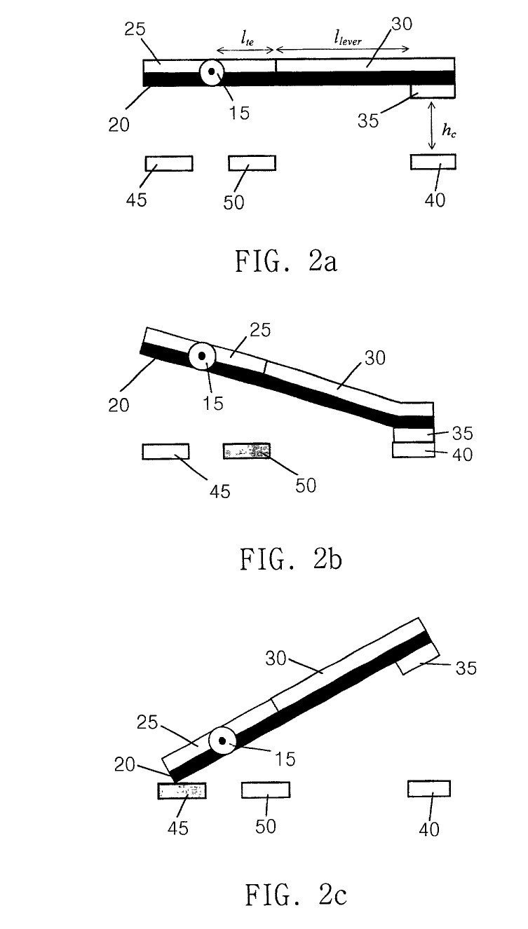

FIG. 2a is a side view illustrating a zero bias state of the push-pull type micromachined microswitch according to the illustrated embodiment of the present invention. As shown in FIG. 2a, the fixed electrodes, that is, the push electrode 45 and pull electrode 50, attached to the base plate 55, and the transmission line 40 are maintained to be parallel to the rotating electrode 25 and movable contact electrode 35. In FIG. 2a, “lₜₑ” represents the length of a portion of the rotating electrode 25 facing one of the fixed electrodes, that is, the pull electrode 50, “lₗₑᵥₑᵣ” represents the length of the lever 30. In FIG. 2a, “h_{c}” represents the distance between the movable contact electrode 35 and the transmission line 40. The distance h_{c} can be expressed by the following Expression 1:

$${h}_{c} = ( 2 + \frac{{l}_{lever}}{{l}_{te}} ) {h}_{0} \qquad [ Expression 1 \}$$

where, “h₀” represents the initial distance between the movable contact electrode 35 and the transmission line 40.

Referring to Expression 1, it can be found that the distance h_{c} having a relation with isolation (insulation) increases as the length lₗₑᵥₑᵣ of the lever 30 increases. Accordingly, it is possible to lower the operating voltage while maintaining a high isolation by decreasing the initial distance h₀. This is because it is possible to adjust the distance h_{c} by the length lever of the lever 30 while maintaining the initial distance h₀ to be small.

FIG. 2b is a side view illustrating the ON state of the push-pull type micromachined microswitch according to the illustrated embodiment of the present invention. This state corresponds to the On state of a voltage Vₚᵤₗₗ. When a voltage is applied to the pull electrode 50, the movable contact electrode 35 is downwardly moved to come into contact with the transmission line 40. In this state, transmission of a signal through the transmission line 40 is allowed. Accordingly, this state is the ON state of the microswitch.

FIG. 2c is a side view illustrating the OFF state of the push-pull type micromachined microswitch according to the illustrated embodiment of the present invention. This state corresponds to the On state of a voltage Vₚᵤₛₕ. When the voltage applied to the pull electrode 50, and a voltage is then applied to the push electrode 45, the movable contact electrode 35 is upwardly moved, so that it is separated from the transmission line 40. Accordingly, this state is the OFF state of the microswitch. In this OFF state, the distance h_{c} between the movable contact electrode 35 and the transmission line 40 is considerably large because its increase is proportional to the length of the lever 30.

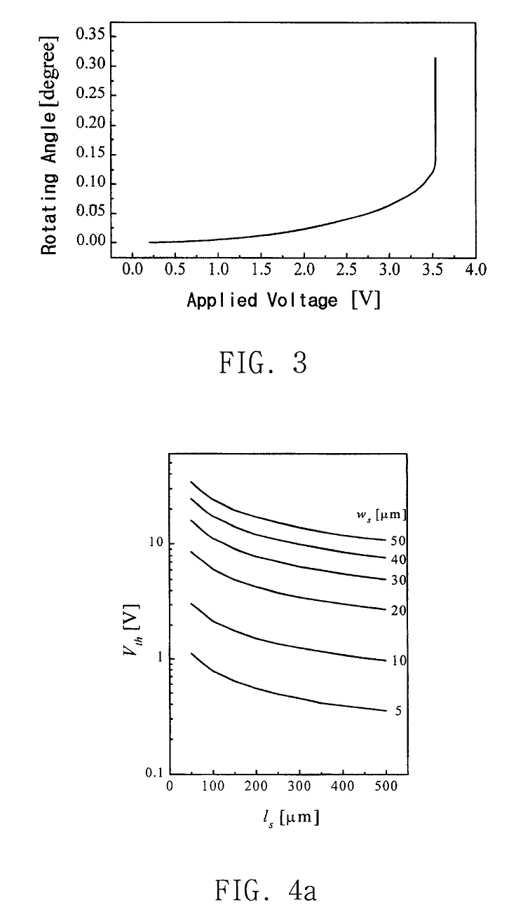

FIG. 3 is a graph depicting a variation in the angle of the rotation generated in the push-pull type micromachined microswitch according to the illustrated embodiment of the present invention, depending on the applied voltage. Referring to FIG. 2c, it can be found that the OFF voltage of the microswitch, that is, Vₚᵤₛₕ, corresponds to a threshold voltage. This is because the rotating electrode 25 is directly in contact with the push electrode 45. Referring to FIG. 2b, it can also be found that the ON voltage of the microswitch, that is, Vₚᵤₗₗ, is lower than the threshold voltage because the movable contact electrode 35 comes into contact with the transmission line 40 before the rotating electrode 25 comes into contact with the pull electrode 50. Accordingly, the rotating angle resulting from the OFF voltage is greater than the rotating angle resulting from the ON voltage. In other words, the operating voltage of the microswitch is lower than the threshold voltage while approximating to the threshold voltage.

Now, a method for deriving the operating voltage will be described. Since the switching operation of the microswitch is achieved by virtue of an electrostatic torque in accordance with the present invention, the operating voltage can be derived, based on the relation between the electrostatic torque, Te, and the rotating angle, θ, as expressed by the following Expression 2:

$${T}_{e} ( θ ) = \frac{{ϵ}_{o} {V}^{2} {w}_{te}}{2 {SIN}^{2} θ} [ \frac{{l}_{te} SIN θ}{{h}_{o} - {l}_{e} SIN θ + \frac{{t}_{d}}{{ϵ}_{d}}} + ln ( {h}_{o} - {l}_{te} SIN θ + \frac{{t}_{d}}{{ϵ}_{d}} ) - \frac{{l}_{e} SIN θ}{{h}_{o} - {l}_{e} SIN θ + \frac{{t}_{d}}{{ϵ}_{d}}} - ln ( {h}_{o} - {l}_{e} SIN + \frac{{t}_{d}}{{ϵ}_{d}} ) ] \qquad [ Expression 2 ]$$

where, “V” represents a voltage applied, “Wₜₑ” represents the width of the rotating electrode, and “l_{be}” represents the length of each fixed electrode (push/pull electrode).

In Expression 2, “lₑ” corresponds to “lₜₑ−l_{be}”. Also, “t_{d}” represents the thickness of the rotating plate made of an insulating material and maintained to be in contact with the rotating electrode, and “ε” represents the dielectric constant of the insulating material. In an equilibrium state, the electrostatic torque Tₑ is equal to a return torque Tᵣ. This return torque Tᵣ can be expressed by the following Expression 3:

$${T}_{r} ( θ ) = \frac{GJ θ}{2 {l}_{s}} \qquad [ Expression 3 ]$$

where, “lₛ” represents the length of the torsion spring, “G” represents a shear coefficient, and “J” represents the ultimate inertial moment of the torsion spring. The ultimate inertial moment J of the torsion spring can be expressed by the following Expression 4:

$$J = \frac{{w}_{s} {t}_{s}}{12} ( {w}_{s}^{2} + {t}_{s}^{2} ) \qquad [ Expression 4 ]$$

where, “Wₛ” and “tₛ” represent the width and thickness of the torsion spring, respectively. Based on the above Expressions, the relation between the rotating angle θ and the applied voltage can be derived.

After composing the above mentioned Expression, the following Expression 5 can be induced.

Tₑ(θ)=Tᵣ(θ) [Expression 5]

Although the solution of Expression 5 can be derived when the operating voltage V is small, there is no solution of Expression 5 when the operating voltage V is higher than the threshold voltage. This means that the rotating electrode 25 comes into contact with the push electrode 45 due to an abrupt voltage decrease from the threshold voltage.

In designing a microwave switch fabricated using a micromachining technique, it is preferentially necessary to take into consideration the switching voltage and radio frequency (RF) characteristics of the microwave switch. In order to allow the use of a low operating voltage, it is necessary to optimize the geometrical dimensions of operating elements in the microswitch. In particular, the moving contact element of the microswitch corresponding to the moving contact electrode 35 in the illustrated case should be precisely designed in order to obtain superior RF characteristics.

The variation in threshold voltage depending on diverse geometrical dimensions will now be described.

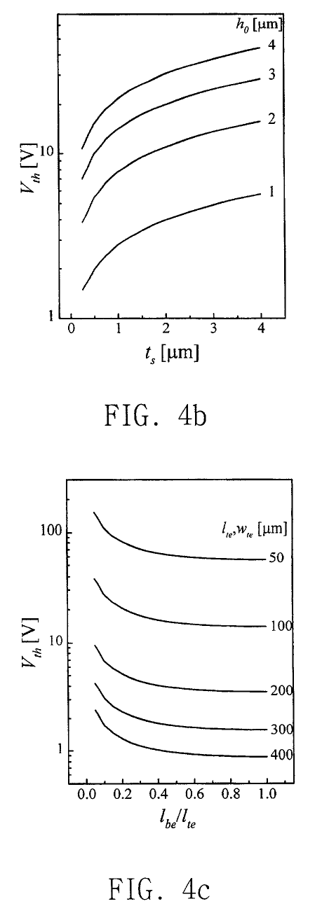

FIG. 4a is a graph depicting a variation in the threshold voltage, Vₜₕ, of the push-pull type micromachined microswitch according to the illustrated embodiment of the present invention, depending on a variation in the width Wₛ of the torsion spring and a variation in the length lₛ of the torsion spring. Referring to FIG. 4a, it can be found that the dependency of the threshold voltage Vₜₕ on the spring width Wₛ is higher than the dependency of the threshold voltage Vₜₕ on the spring length lₛ.

FIG. 4b is a graph depicting a variation in the threshold voltage, Vₜₕ, of the push-pull type micromachined microswitch according to the illustrated embodiment of the present invention, depending on a variation in the initial height h₀ of the movable contact electrode 35 and a variation in the thickness tₛ of the torsion spring. Referring to FIG. 4b, it can be found that the initial height ho of the movable contact electrode 35, that is, the initial distance between the rotating electrode 25 and the fixed electrodes 45 and 50 has an influence on the operating voltage higher than the influence of the spring thickness tₛ on the operating voltage. If no push-pull configuration as mentioned above is not used, then the maximum distance h_{c} between the movable contact electrode 35 and the transmission line 40 in the OFF state of the microswitch is equal to the initial height or distance h₀. In this case, the initial distance h₀ should be sufficiently large in order to obtain a desired RF insulation. Where the spring thickness tₛ is 2 μm, and the initial distance h₀ is 4 μm, the microswitch has a threshold voltage of about 30 V. Where a push-pull configuration is used, however, it is possible to reduce the initial distance h₀ while maintaining the same isolation (insulation) as that in the case using no push-pull configuration. It is also possible to reduce the threshold voltage to 10 V corresponding to about ⅓ the threshold voltage in the microswitch using no push-pull configuration. In accordance with the present invention in which the lever 30 is connected to the rotating plate 20, it is possible to further reduce the initial distance h₀ while maintaining the same isolation as that in the push-pull type microswitch not using the lever 30. Where the length lₗₑᵥₑᵣ of the lever 30 is equal to two times the length lₜₑ, and the initial distance h₀ is 1 μm, the microswitch of the present invention has a threshold voltage reduced to 3.5 V corresponding to about ⅓ the threshold voltage in the push-pull type microswitch not using the lever 30.

FIG. 4c is a graph depicting a variation in the threshold voltage, Vₜₕ, of the push-pull type micromachined microswitch according to the illustrated embodiment of the present invention, depending on a variation in the length l_{be} of the lower electrode, that is, the push or pull electrode 45 or 50, a variation in the length lₜₑ of the upper electrode, that is, the rotating electrode 25, and the width Wₜₑ of the rotating electrode 25. Referring to FIG. 4c, it can be found that a decrease in threshold voltage occurs as the length lₜₑ and width Wₜₑ of the upper rotating electrode 25 increase. It can also be found that where the ratio between the length l_{be} of the lower electrode and the length lₜₑ of the upper electrode, l_{be}/lₜₑ, is more than about 0.4, there is no considerable reduction in threshold voltage.

As apparent from the above description, respective dimensions of diverse elements included in the microswitch considerably effect on the operation of the microswitch. Thus, these dimensions are important factors in designing the microswitch. The dimensions in the microswitch fabricated in accordance with the present invention are described in the following Table 1.

TABLE 1

| Parameters | Dimension [μm] |
|---|---|
| Width of Spring (Wₛ) | 20 |
| Length of Spring (Iₛ) | 300 |
| Width of Upper Rotating Electrode (Wₜₑ) | 100 to 400 |
| Length of Upper Rotating Electrode (lₜₑ) | 100 to 400 |
| Length of Lower Fixed Electrode (l_{be}) | 0.8 lₜₑ |
| Length of Lever (lₗₑᵥₑᵣ) | 1 lₜₑ to 3 lₜₑ |
| Width of Lever (Wₗₑᵥₑᵣ) | 50 |

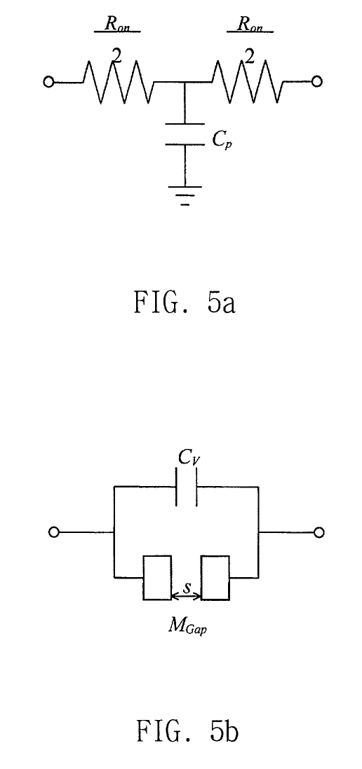

FIG. 5a is a circuit diagram illustrating an RF model established in the ON state of the push-pull type micromachined microswitch according to the illustrated embodiment of the present invention. In FIG. 5a, “Cₚ” represents a parasitic capacitance formed between the movable contact electrode 35 and the upper rotating electrode 25.

FIG. 5b is a circuit diagram illustrating an RF model established in the OFF state of the push-pull type micromachined microswitch according to the illustrated embodiment of the present invention. Referring to FIG. 5b, it can be found that the RF model has a configuration in which a vertical coupling capacitance Cᵥ and a capacitance formed by virtue of the gap M_{Gap} of the microstrip transmission line are connected together in parallel.

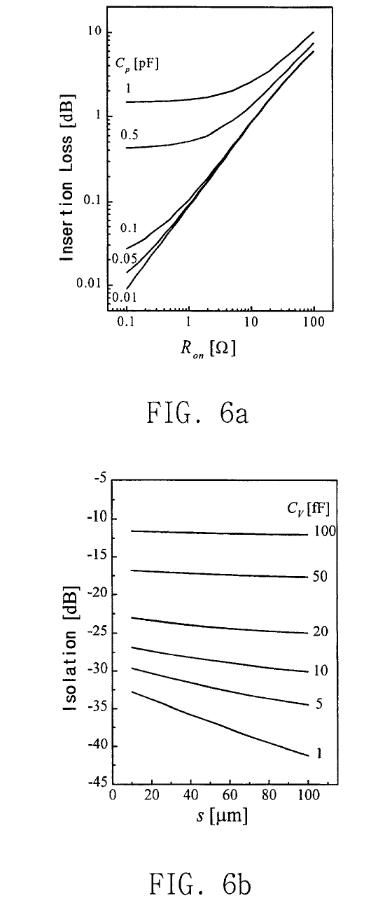

FIG. 6a is a graph depicting RF characteristics exhibited in the ON state of the push-pull type micromachined microswitch according to the illustrated embodiment of the present invention. FIG. 6a illustrates a variation in insertion loss at 4 GHz depending on a variation in the resistance, Rₒₙ, generated in the ON state of the microswitch and a variation in parasitic capacitance. Where the ON resistance Rₒₙ is higher than 5 Ω, it considerably effect on the insertion loss. On the other hand, where the ON resistance Rₒₙ is not higher than 5 Ω, the insertion loss is mainly determined by the parasitic capacitance.

FIG. 6b is a graph depicting RF characteristics exhibited in the OFF state of the push-pull type micromachined microswitch according to the illustrated embodiment of the present invention. FIG. 6b illustrates a variation in isolation (insulation) at 4 GHz depending on a variation in the vertical coupling capacitance Cᵥ and a variation in the gap width s of the microstrip transmission line. Where the vertical coupling capacitance Cᵥ is higher than 50 fF, the insulation is mainly determined by the vertical coupling capacitance Cᵥ. On the other hand, where the vertical coupling capacitance Cᵥ is not higher than 50 fF, the insulation is mainly determined by the gap width s of the microstrip transmission line.

Since the movable contact electrode 35 has the above mentioned characteristics, it should be carefully designed in order to obtain an excellent RF operation. An increase in the contact area of the movable contact electrode 35 results in a decrease in the ON resistance Rₒₙ and an increase in the capacitance C_{off}. In accordance with the present invention, the movable contact electrode 35 is designed to have a contact area of 90 μm×90 μm.

In designing the microswitch, it is also important to achieve an appropriate stress control. Where the microswitch mainly has a tensile stress exerting a downward bending force, a degradation in insulation occurs. On the other hand, where the microswitch mainly has a compressive stress exerting an upward bending force, it is impossible to make the movable contact electrode 35 come into contact with the transmission line 40 by a pulling operation. For the constituting layers of the microswitch, an Au-plated plate is mainly used because it exhibits a low shear coefficient and an appropriate stress. The entire structure of movable elements is made of an SiNx (200 nm) layer having a multilayer structure. Ti/Au layers (20 nm/50 nm) are deposited over the SiNx layer. The resulting structure is then plated with an Au layer (1.1 μm). Thus, the entire structure of movable elements has a stress compensation structure. The SiNx layer has a compressive stress, thereby compensating for the electroplated Au layer having an appropriate tensile stress gradient. The SiNx layer having the compressive stress serves as an insulating layer for insulating the movable contact electrode 35 from DC bias. The insulating layer constitutes the rotating plate 20. The SiNx layer having the compressive stress also prevents a short circuit from occurring between the upper rotating electrode and the lower fixed electrodes. The entire structure of movable elements has a total thickness of 1.4 μm.

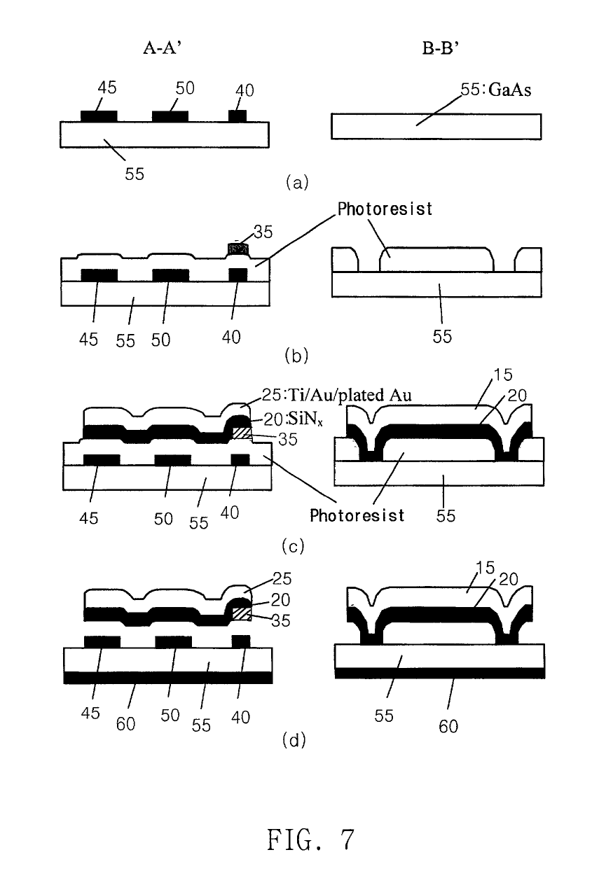

FIGS. 7a to 7d are cross-sectional views respectively illustrating sequential processing steps of a procedure for fabricating the push-pull type micromachined microwave switch according to the present invention. Referring to FIGS. 7a to 7d, a GaAs substrate is prepared for the base plate 55. Other insulating or semi-insulating substrates made of Si, alumina, and quartz exhibiting a high resistance may also be used for the base plate 55.

Now, the microswitch fabrication procedure will be described in the order illustrated in FIGS. 7a to 7d. In each of FIGS. 7a to 7d, the left portion is a cross-sectional view taken along the line A-A of FIG. 1 whereas the right portion is a cross-sectional view taken along the line B-B of FIG. 1. Referring to FIG. 7a, the formation of the transmission line 40 and lower fixed (push/pull) electrodes 45 and 50 is then carried out by plating Au on a Ti/Au seed metal formed over the upper surface of the base plate 55 at desired regions, respectively. After the line and electrode formation, the seed metal is removed. Referring to FIG. 7b, a sacrificial layer is then formed on the resulting structure, using a photoresist such as AZ5241, thereby defining a region where the fixed shafts are to be formed. The photoresist is treated at a temperature of 150° C. during subsequent processing steps so that it can withstand the processing conditions of those processing steps. The formation of the movable contact element 35 is then carried out by depositing Au/Ti layers (0.5 μm/0.05 μm) over the sacrificial layer, and partially wet-etching the Au/Ti layers. Referring to FIG. 7c, the entire structure of movable elements is formed on the structure obtained after the formation of the movable contact element 35 by depositing an SiNx layer over the structure obtained after the formation of the movable contact element 35, depositing Ti/Au layers over the SiNx layer, plating an Au layer, and then patterning those layers. The Au layer is adapted to provide a high conductivity and an anti-oxidation property. The Ti layer is adapted to increase the bonding force of the Au layer to the SiNx layer. Referring to FIG. 7d, the photoresist is then completely removed. After the removal of the photoresist, an Au layer is deposited on the lower surface of the base plate 55 opposite to the movable structure, to form the ground layer 60. Thus, the entire fabrication process is completed. A releasing process is then conducted. In order to avoid an attachment problem, the releasing process is carried out using an O₂ plasma dry etching method. The movable contact electrode 35 is upwardly spaced apart from the transmission line by a distance of 1 μm.

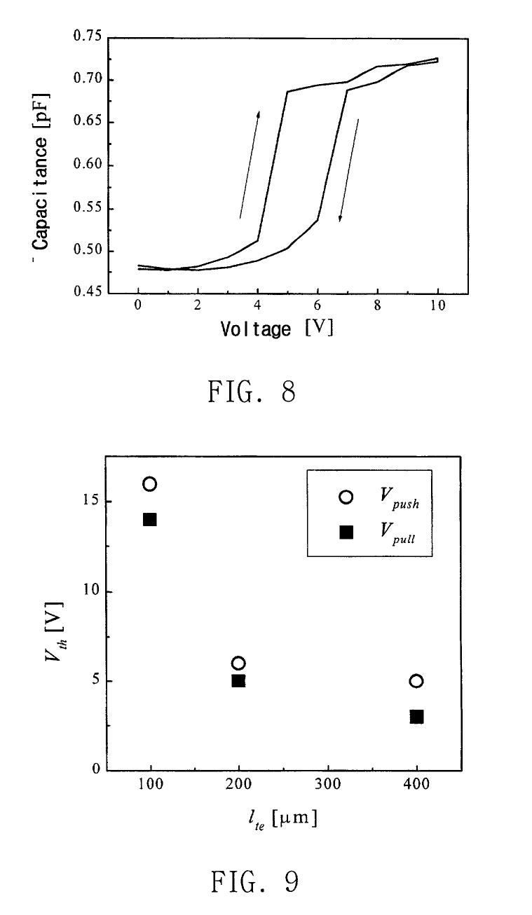

FIG. 8 is a graph depicting a variation in capacitance in the push-pull type micromachined microswitch according to the illustrated embodiment of the present invention, depending on the applied voltage. FIG. 8 illustrates a relation of the capacitance formed between the upper rotating electrode 25 and the lower fixed electrodes 45 and 50 with respect to the applied voltage. Referring to FIG. 8, it can be found that an abrupt variation in capacitance occurs at 4 V.

FIG. 9 is a graph depicting respective variations in voltages Vₚᵤₗₗ and Vₚᵤₛₕ in the push-pull type micromachined microswitch according to the illustrated embodiment of the present invention, depending on a variation in the length lₜₑ of the upper rotating electrode 25. Referring to FIG. 9, it can be found that the voltage Vₚᵤₗₗ ranges from 3 V to 14 V whereas the voltage Vₚᵤₛₕ ranges from 5 V to 16 V. It is also found that the voltage Vₚᵤₗₗ is always less than the voltage Vₚᵤₛₕ. This is because the initial gap between the upper rotating electrode 25 and the lower fixed electrodes 45 and 50 is small to correspond to 1 μm.

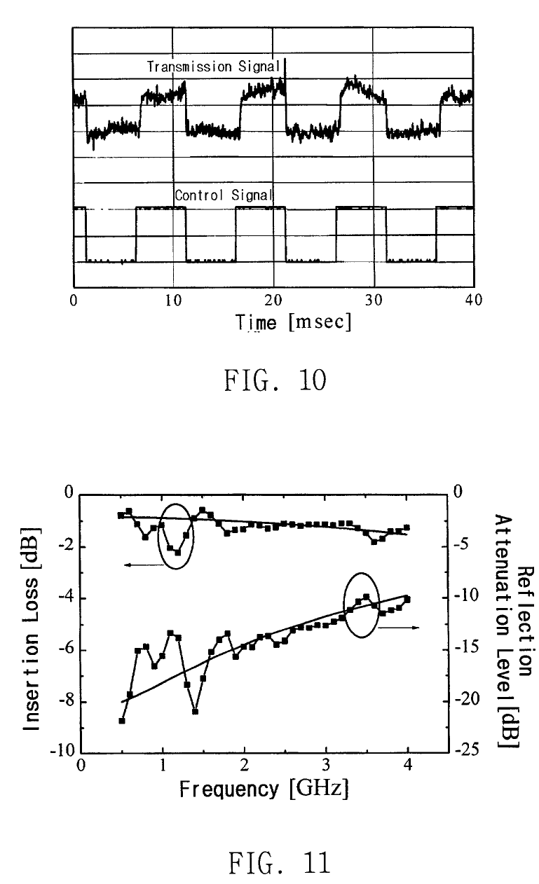

FIG. 10 is a waveform diagram illustrating a dynamic response of the push-pull type micromachined microswitch according to the illustrated embodiment of the present invention. FIG. 10 illustrates a dynamic response at 100 Hz. Referring to FIG. 10, it can be found that both the closure and release times are 0.6 ms in the push-pull type micromachined microswitch. In microswitches having no push-pull configuration, the closure and release times are 0.5 ms and 0.1 ms, respectively. In FIG. 10, the control signal is a signal applied between the pull electrode and the rotating electrode, and the transmission signal is a signal outputted from the transmission line when a DC current is inputted to the transmission line in accordance with the control signal. That is, when the control signal has a “high” level, the microswitch is rendered to be in its ON state, so that DC current is transmitted. On the other hand, when the control signal has a “low” level, the microswitch is rendered to be in its OFF state, so that no DC current is transmitted. Although a microwave signal is practically used as the transmission signal, DC current was used as the transmission signal in order to evaluate dynamic response characteristics.

FIG. 11 is a graph depicting characteristics exhibited in the ON state of the push-pull type micromachined microswitch according to the illustrated embodiment of the present invention. Referring to FIG. 11, it can be found that the resistance Rₒₙ and the parasitic capacitance Cₚ are 10 Ω and 0.6 pF, respectively. Referring to FIG. 11, it can be found that the insertion loss is less than 2 dB. It can also be found that when it is desired to reduce the insertion loss at 4 GHz to 0.1 dB, it is necessary to reduce the resistance Rₒₙ to a level of less than 1 Ω and the parasitic capacitance Cₚ to a level of less than 50 fF.

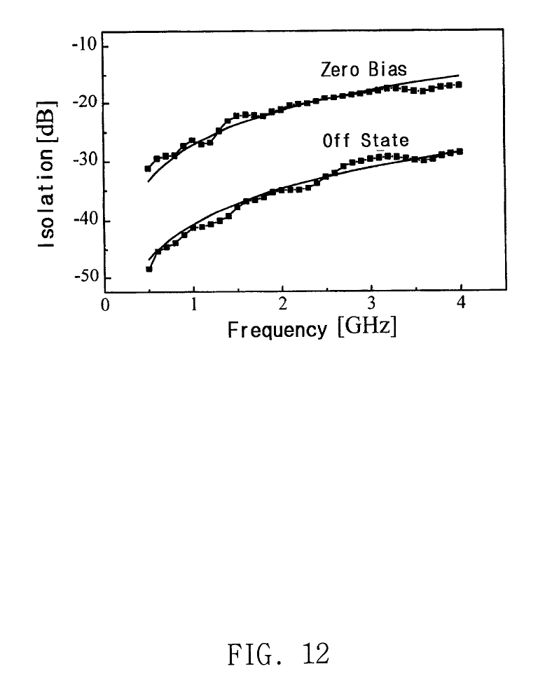

FIG. 12 is a graph depicting characteristics exhibited in the OFF state of the push-pull type micromachined microswitch according to the illustrated embodiment of the present invention. Referring to FIG. 12, it can be found that an isolation of more than 17 dB is exhibited in a zero-bias state. This means that the isolation is improved by about 10 dB in that the isolation exhibited in the push operation is more than 28 dB. Although the vertical coupling capacitance Cᵥ measured in the zero-bias state is 60 fF, it is considerably reduced in accordance with the push operation. Referring to FIG. 12, it can be found that the vertical coupling capacitance Cᵥ is reduced to 6 fF. The total capacitance C_{off} in the zero-bias state is calculated to be 70 fF. In accordance with the push operation, the total capacitance C_{off} is reduced to 15 fF. The gap width s of the microstrip transmission line 40 is preferably 20 μm. When this gap width s increases, an increase in isolation occurs.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

As apparent from the above description, the microswitch of the present invention has advantages in that it exhibits a low insertion loss in a transmission state while exhibiting a high isolation in a non-transmission state.

The microswitch of the present invention also has an advantage in that it can operate using a low operating voltage.

What is claimed is:

1. A push-pull type micromachined microwave switch comprising:
an insulating base plate;
fixed electrodes arranged on the insulating base plate;
a plurality of fixed shafts attached to the base plate and adapted to firmly support a plurality of torsion springs, respectively;
the torsion springs each connected at one end thereof to an associated one of the fixed shafts;
a rotating plate arranged over the fixed electrodes to face the fixed electrodes and connected to respective other ends of the torsion springs;
a rotating electrode attached to an upper surface of the rotating plate;
a lever connected at one end thereof to the rotating plate;
a movable contact electrode attached to a lower surface of the lever at the other end of the lever so that it is firmly supported by the lever; and
a transmission line arranged on the base plate so that it faces the movable contact electrode.

2. The push-pull type micromachined microwave switch according to claim 1, wherein the torsion springs, the rotating plate, and the lever are made of an insulator.

3. The push-pull type micromachined microwave switch according to claim 1, wherein the fixed electrodes are a push electrode and a pull electrode, respectively.

4. The push-pull type micromachined microwave switch according to claim 1, further comprising a bending electrode fixed to the insulating base plate and arranged to face a portion of the lever.

5. The push-pull type micromachined microwave switch according to claim 1, wherein the transmission line is divided into two line portions defining a gap therebetween, the gap facing the movable contact electrode.

6. The push-pull type micromachined microwave switch according to claim 1, wherein the transmission line is a microstrip line.

7. The push-pull type micromachined microwave switch according to claim 1, wherein the transmission line is a coplanar waveguide.

8. The push-pull type micromachined microwave switch according to claim 1, wherein each of the torsion springs has a straight bar shape.

9. The push-pull type micromachined microwave switch according to claim 1, wherein each of the torsion springs has a shape provided with irregularities.

10. A push-pull type micromachined microwave switch comprising:
an insulating base plate coupled to a microwave ground;
fixed electrodes arranged on the insulating base plate;
a plurality of fixed shafts attached to the base plate and adapted to firmly support a plurality of torsion springs, respectively;
the torsion springs each connected at one end thereof to an associated one of the fixed shafts;
a rotating plate arranged over the fixed electrodes to face the fixed electrodes and connected to respective other ends of the torsion springs;
a rotating electrode attached to an upper surface of the rotating plate;
a lever connected at one end thereof to the rotating plate;
a movable contact electrode attached to a lower surface of the lever at the other end of the lever so that it is firmly supported by the lever; and
a transmission line arranged on the base plate so that it faces the movable contact electrode.

11. The push-pull type micromachined microwave switch according to claim 10, wherein the torsion springs, the rotating plate, and the lever are made of an insulator.

12. The push-pull type micromachined microwave switch according to claim 10, wherein the transmission line is provided with a dielectric at an upper surface thereof facing the movable contact electrode.

13. The push-pull type micromachined microwave switch according to claim 1, wherein the transmission line is a microstrip line.

14. The push-pull type micromachined microwave switch according to claim 10, wherein the transmission line is a coplanar waveguide.
